(19) United States
(12) Patent Application Publication
(10) Pub. No.: US 2013/0109475 A1
(43) Pub. Date: May 2, 2013

(54) GAME SYSTEM, CONTROL METHOD THEREFOR, AND A STORAGE MEDIUM STORING A COMPUTER PROGRAM

(71) Applicants: Takashi Hamano, Minato-ku (JP); Nobuhiro Onodera, Minato-ku (JP)

(72) Inventors: Takashi Hamano, Minato-ku (JP); Nobuhiro Onodera, Minato-ku (JP)

(21) Appl. No.: 13/809,845

(22) PCT Filed: Jul. 14, 2011
(86) PCT No.: PCT/JP2011/066125

§ 371 Date: Jan. 11, 2013

(30) Foreign Application Priority Data
Jul. 15, 2010 (JP) 2010-161101

(51) Int. Cl. A63F 13/00

(52) U.S. Cl. CPC A63F 13/00
USPC 463/31

(57) ABSTRACT

Disclosed is a game system wherein two-dimensional images are generated on the basis of a virtual three-dimensional space used in the progression of a game, and a game screen using said two-dimensional images is displayed on a large monitor (4). Said game system is provided with: small monitors (7) separate from the large monitor (4); and small cameras (8) that can image the area around the large monitor (7). The game system combines images taken by the small cameras (8) together with other images and outputs the results to the small monitors (7).

### TECHNICAL FIELD

The present invention relates to a game system using a virtual three-dimensional (3D) space, a control method therefor, and a computer program.

### BACKGROUND ART

Games, in which a two-dimensional (2D) image is generated based on a virtual 3D space used for the progress of a game or the like and the 2D image is used as a game image, have been known (for example, see Patent Literature 1).

Patent Literature 1: Japanese Patent Application Laid-Open No. 2002-251626.

### SUMMARY OF INVENTION

### Technical Problem

In the game discussed in Patent Literature 1, a player plays a game while feeling a virtual 3D space through a display device. Thus, a range of a space that a player can feel as a game space can be extended by increasing the size of a display device that displays a game image or the number of display devices. Then, amusement of a game can be improved by extending the range that the player feels as the game space. Meanwhile, in the game discussed in Patent Literature 1, since a form of the virtual 3D space is used as the game image as it is, it is necessary to change the size of the virtual 3D space set as the game space according to a change in the size of the display device or the like.

In this regard, an object of the present invention is to provide a game system, a control method therefor, and a computer program, which are capable of causing an image displayed on a main display device to be made different from an image displayed on a sub display device without changing the size of the virtual 3D space.

### Solution to Problem

A game system of the present invention is a game system in which a two-dimensional (2D) image is generated based on a virtual three-dimensional (3D) space used for a progress of a game, and a game screen using the 2D image is displayed on a main display device, and wherein the game system comprises: a sub display device separate from the main display device; an image generating device adapted and configured to generate a predetermined image to be output to the sub display device; and a synthesis image output device adapted and configured to synthesize a predetermined image generated by the image generating device with another image, and output a synthesis result to the sub display device.

According to the present invention, by using a synthesis image, an image to be displayed on the main display device can be made different from an image to be displayed on the sub display device without changing the size of the virtual 3D space. Thus, for example, in the form of the virtual 3D space of the same range, the image of the main display device can be made different from the image of the sub display device. As a result, the form of the virtual 3D space of the same range can have multiplicity. In addition, for example, when the image of the real space is used as the image displayed on the sub display device, by synthesizing another image with the real space, the range that can be used as the game space can be increased up to the real space as well as the virtual 3D space. As described above, by giving multiplicity to the virtual 3D space and extending the game space up to the real space, a space that can be used for the progress of a game or the like can be variously changed. Thus, by making the image displayed on the main display device different from the image displayed on the sub display device using the synthesis image, the space used for the progress of a game or the like can have diversity without changing the size of the virtual 3D space.

In an embodiment of the game system of the present invention, a photographing device adapted and configured to be able to photograph an area around the main display device may be further provided, wherein the photographing device may be used as the image generating device, and an image photographed by the photographing device may be used as the predetermined image. In this case, it is possible to extend the space that can be used for the progress of a game or the like up to the range of the real space photographed by the photographing device. In addition, since the real space is used for the progress of a game or the like, realistic sensation of the game can be improved.

In the embodiment in which the photographing device is provided, an input device adapted and configured to receive a player's operation is further provided, wherein the photographing device may be provided in the input device, and the input device may be configured so as to be able to move such that the photographing device can photograph an area around the main display device. In this case, since the photographing range of the photographing device changes according to an operation of the input device operated by the player, it is possible to set the real space which can be extended as the space which can be used for the progress of a game or the like according to the operation of the input device. In addition, as a result, since the player's operation can be reflected in the image of the sub display device, realistic sensation of the game can be further improved.

In an embodiment of the game system of the present invention, a detecting device adapted and configured to detect a player's action may be further provided, and wherein the image generating device may generate a 2D image of a space of a part of the virtual 3D space based on the player's action detected by the detecting device as the predetermined image. In this case, in the form of the virtual 3D space of the same range, the image of the main display device can be made different from the image of the sub display device. Thus, for example, it is possible to cause an object of the enemy character, which is not present in the image that is the form of the virtual 3D space of the same range and displayed on the main display device, to be present in the image displayed on the sub display device. As a result, the form of the virtual 3D space of the same range can have multiplicity.

In the embodiment in which the detecting device is provided, an input device adapted and configured to be movable and receive a player's operation may be further provided, and wherein the detecting device may be provided in the input device and detect an operation of the input device as the player's action, and the input device may have a movable range which is set such that the whole space of the virtual 3D space corresponding to the game screen can be set as the part of the space. In this case, since the operation of the input device can be detected as the player's action, virtual 3D space according to the operation of the input device can have multiplicity. In addition, since the player's action can be reflected in the image of the sub display device, realistic sensation of the game can be improved.

In addition, in the embodiment in which the input device is provided, the input device is not limited to a specific device. For example, in an embodiment of the game system of the present invention, a gun-type controller imitating a gun may be used as the input device.

A control method of the present invention is a control method of controlling a computer incorporated in a game system in which a two-dimensional (2D) image is generated based on a virtual three-dimensional (3D) space used for a progress of a game, and a game screen using the 2D image is displayed on a main display device, and wherein the game system comprises a sub display device separate from the main display device and the control method of controlling the computer comprises the steps: an image generating step that generates a predetermined image to be output to the sub display device; and a synthesis image output step that synthesizes a predetermined image generated by the image generating device with another image, and output a synthesis result to the sub display device.

Further, a computer program for an game system of the present invention is a computer program for a game system in which a two-dimensional (2D) image is generated based on a virtual three-dimensional (3D) space used for a progress of a game, and a game screen using the 2D image is displayed on a main display device, and wherein the game system comprises a sub display device separate from the main display device and the computer program is configured so as to cause a computer which is incorporated in the game system to serve as: an image generating device adapted and configured to generate a predetermined image to be output to the sub display device; and a synthesis image output device adapted and configured to synthesize a predetermined image generated by the image generating device with another image, and output a synthesis result to the sub display device. By executing the control method or the computer program of the present invention, it is possible to realize the game system of the present invention.

### Advantageous Effects of Invention

As described above, according to the present invention, it is possible to cause an image displayed on a main display device to be made different from an image displayed on a sub display device without changing the size of the virtual 3D space.

### BRIEF DESCRIPTION OF DRAWINGS

FIG. 1 is a diagram schematically illustrating an external appearance of a game machine to which a game system according to an embodiment of the present invention is applied;

FIG. 2 is a diagram schematically illustrating the inside of a dedicated housing included in a game machine;

FIG. 3 is a schematic diagram illustrating a control system of a game machine;

FIG. 4 is a perspective view of a gun-type controller seen from a right front;

FIG. 5 is a diagram schematically illustrating a movable range of a gun-type controller;

FIG. 6 is a diagram schematically illustrating an example of the inside of a dedicated housing 2 in which a player is playing a game;

FIG. 7 is a flowchart illustrating an example of a synthesis image generating process routine executed by an image processing unit;

FIG. 8A illustrates an example of an image around a large monitor photographed from a fixed position as another embodiment of the present invention; and

FIG. 8B illustrates an example of an image around a large monitor after a predetermined time from an example of FIG. 8A.

### DESCRIPTION OF EMBODIMENTS

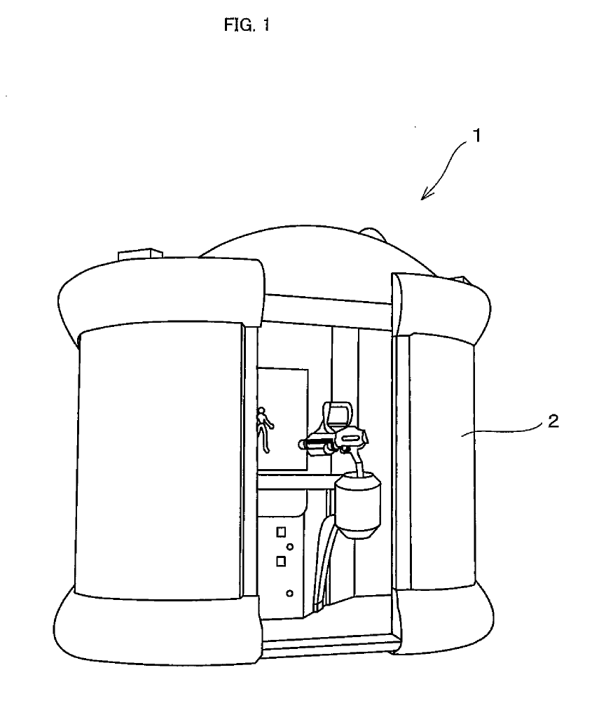

Hereinafter, a game machine to which a game system according to an embodiment of the present invention is applied will be described with reference to the drawings. Incidentally, the game machine of the present invention provides a game of an action type in which a player explores a virtual game space and carries out a predetermined mission by operating a character (which may be hereinafter referred to as a “player character”) set as an operation target. FIG. 1 is a diagram schematically illustrating an external appearance of a game machine 1. As illustrated in FIG. 1, the game machine 1 includes a dedicated housing 2 of a jug type. An elliptical space is formed inside the dedicated housing 2, and the player plays a game inside the dedicated housing 2.

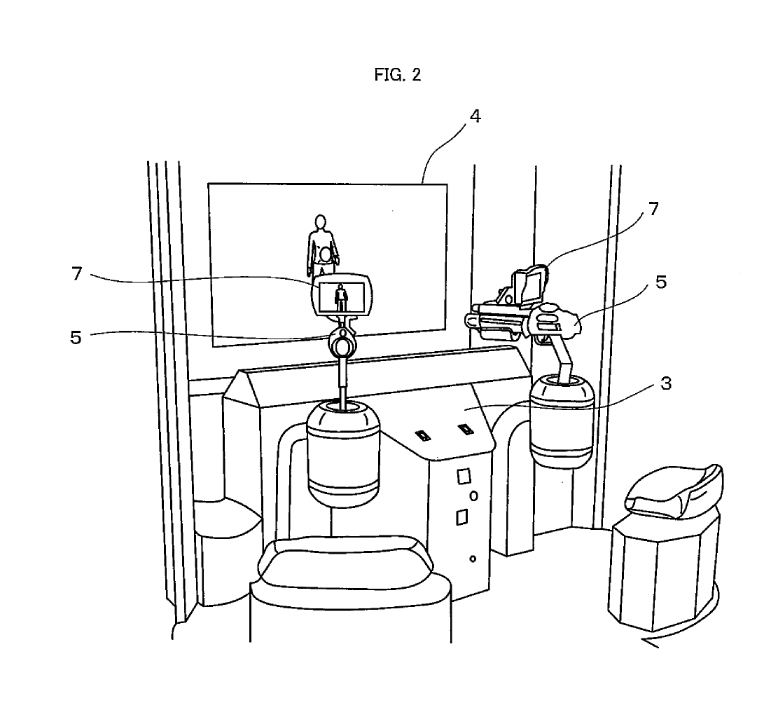

FIG. 2 is a diagram schematically illustrating the inside of the dedicated housing 2. As illustrated in FIG. 2, a game machine main body 3, a large monitor 4 (for example, a liquid crystal display device (LCD)) serving as a main display device, and two gun-type controllers 5 serving as an input device that symbolizes a weapon given to the player are provided inside the dedicated housing 2. In addition, a small monitor 7 serving as a sub display device is provided on an upper portion of each gun-type controller 5. Incidentally, although not illustrated in the drawings, the game machine main body 3 may be provided with various kinds of input devices and output devices disposed in a typical game machine for business such as a button to make a selection or a decision, a power switch, and a volume operating switch.

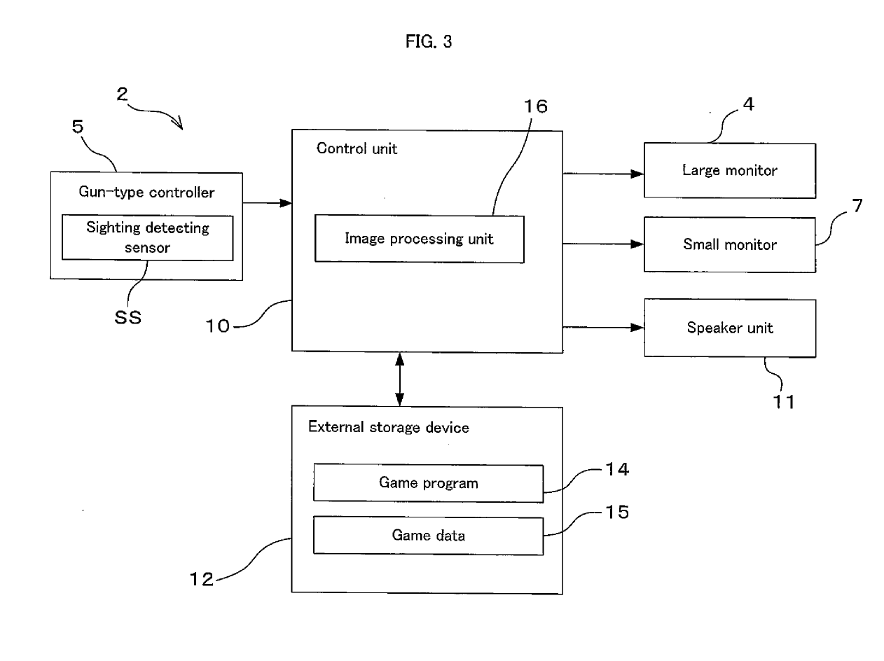

Various kinds of devices are stored inside the game machine main body 3. FIG. 3 is a schematic diagram illustrating a control system of the game machine 1 including some of various kinds of devices in the game machine main body 3. As illustrated in FIG. 3, a control unit 10, a speaker unit 11, and an external storage device 12 are included as various kinds of devices in the game machine main body 3. The control unit 10 is configured as a computer unit in which a microprocessor is combined with peripheral devices such as a main storage device (a random access memory (RAM) or a read only memory (ROM)) or the like, which are necessary for an operation of the microprocessor. The large monitor 4, each small monitor 7, the gun-type controller 5, the speaker unit 11, and the external storage device 12 are connected to the control unit 10. Besides, various kinds of peripheral devices can be connected to the control unit 10, but illustration thereof is not provided.

The external storage device 12 is a storage device including a non-volatile storage medium such as a magnetic storage medium, an optical storage medium, an electrically erasable programmable read-only memory (EEPROM). In addition to an operating system to implement basic control of the control unit 10, a game program 14 serving as application software to execute a game according to a predetermined procedure, and a game data 15 appropriately referred to by the game program 14 are recorded in the external storage device 12. The game data 15 includes a variety of image data of an object or the like. As the control unit 10 reads and executes the game program 14, various kinds of logical devices necessary for execution of a game are generated in the control unit 10. An image processing unit 16 is formed in the control unit 10 as one of the logical devices. The image processing unit 16 executes various kinds of calculation processes necessary for generating an image to be displayed on the large monitor 4 and each small monitor 7. The details of the image processing unit 16 will be described later.

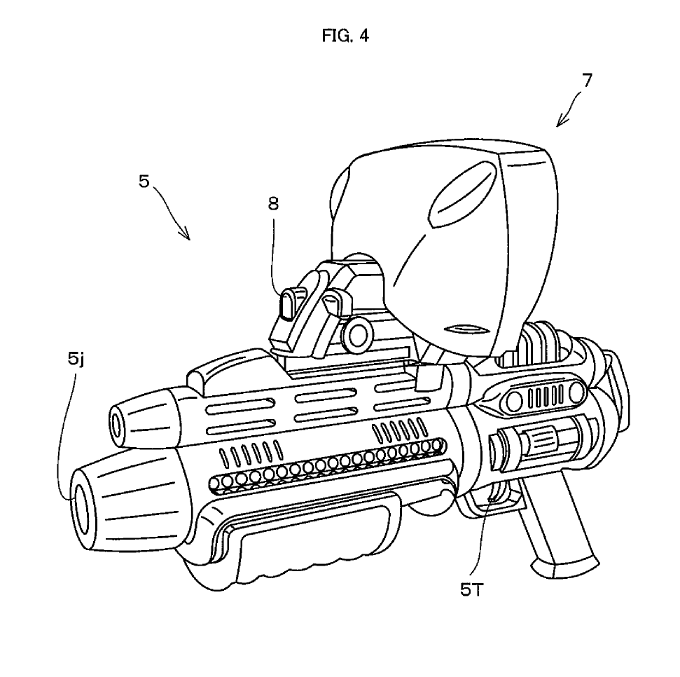

The gun-type controller 5 is provided with a sighting detecting sensor SS serving as a detecting device. FIG. 4 is a perspective view of the gun-type controller 5 seen from the right front. The sighting detecting sensor SS detects a direction in which a muzzle 5j faces. Various kinds of known sensors may be used as the sighting detecting sensor SS. In the present embodiment, as an example of the sighting detecting sensor SS, as will be described later, a biaxial sensor using a lever, which detects a moving direction of the gun-type controller 5, is installed inside a platform to which the gun-type controller 5 is attached. However, the present invention is not limited to this embodiment, and various kinds of sensors such as a gyroscopic sensor, a geomagnetic sensor, or an acceleration sensor may be used as the sighting detecting sensor SS.

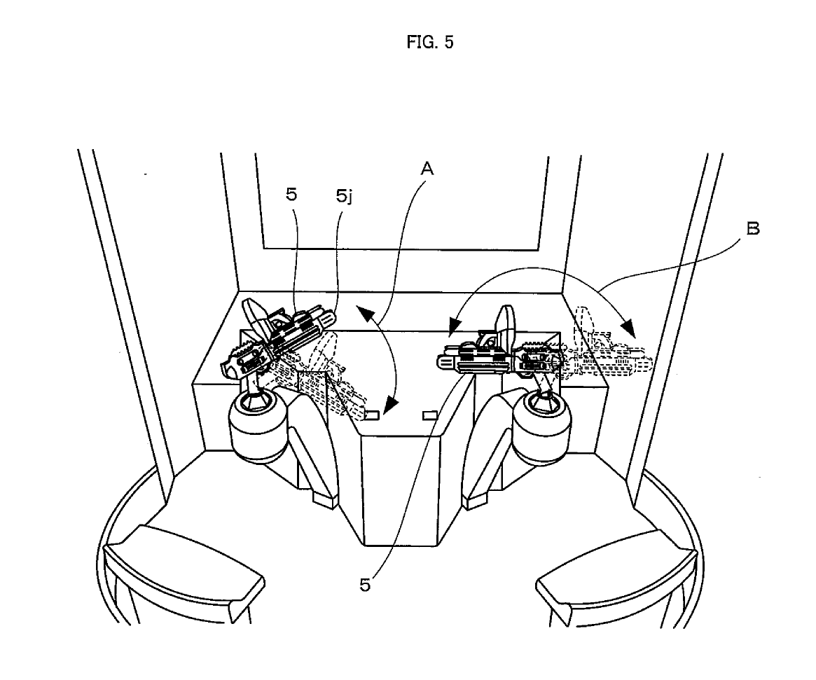

FIG. 5 is a diagram schematically illustrating the movable range of the gun-type controller 5. Both of two arrows A and B of FIG. 5 represent the movable range of the gun-type controller 5. As illustrated in FIG. 5, the gun-type controller 5 is configured so as to be able to move in both in a horizontal direction and a vertical direction. A range in the vertical direction indicated by the arrow A from below to above the large monitor 4 and a range in the horizontal direction indicated by the arrow B from one side to the other side of the dedicated housing 2 are set as the movable range. The sighting detecting sensor SS detects a direction in which the muzzle 5j faces in the movable range indicated by the arrows A and B. Incidentally, in FIG. 5, for convenience of description, the movable range is illustrated for each gun-type controller 5, but in each actual gun-type controller 5, the movable range is set in both the corresponding vertical direction and the horizontal direction.

In addition, in the gun-type controller 5, a small camera 8 serving as a photographing device is provided in front of the small monitor 7 as illustrated in FIG. 4. Each small camera 8 can photograph a predetermined range related to a direction in which the muzzle 5j of each gun-type controller 5 faces. Each gun-type controller 5 outputs an image imaged by each small camera 8 to the control unit 10. In addition, each gun-type controller 5 is provided with a trigger unit 5T serving as an operating unit that receives the player's operation. Each gun-type controller 5 outputs a signal corresponding to an operation of each trigger unit 5T to the control unit 10.

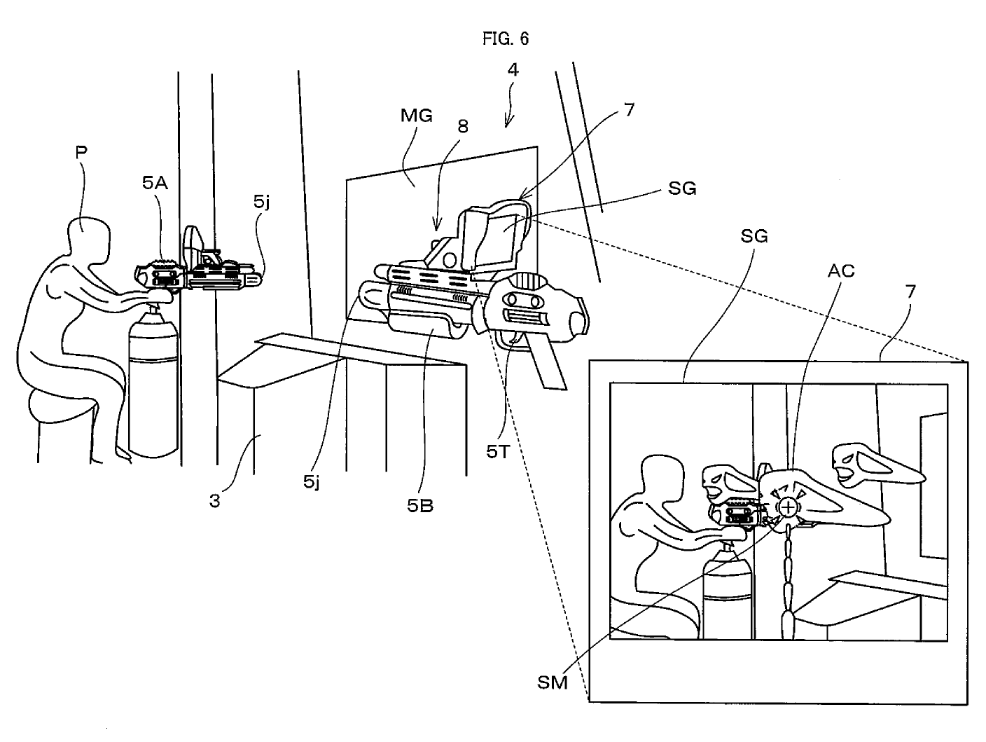

Next, an example of an image displayed on each of the monitors 4 and 7 will be described. FIG. 6 is a diagram schematically illustrating an example of the inside of the dedicated housing 2 in which the player is playing a game. FIG. 6 illustrates an example in which the game of the game machine 1 is being played by two players. Each player uses each gun-type controller 5. The large monitor 4 displays a main image MG representing a form of a virtual 3D game space (not illustrated) such as an indoor place set as a place in which a player character moves. The virtual 3D game space is one in which a game space logically generated on a memory and displayed as the main image MG is expressed as a 3D model. In the example of FIG. 6, one player P is playing a game in a state in which the muzzle 5j of the first gun-type controller 5A faces the main image MG of the large monitor 4.

Meanwhile, the small monitor 7 of each gun-type controller 5 displays a sub image SG according to a direction in which the muzzle 5j faces. An image photographed by the small camera 8 provided in each gun-type controller 5 is used as the sub image SG. In the example of FIG. 6, the other player (not illustrated) causes the muzzle 5j of the second gun-type controller 5B to face one player P. In this case, the small monitor 7 of the second gun-type controller 5B displays an image of a real space photographed by the small camera 8, that is, the player P who is playing the game and the first gun-type controller 5A, and parts of the game machine main body 3 and the large monitor 4 as the sub image SG. Furthermore, an enemy character AC is present on the sub image SG. The enemy character AC is not present on the real space photographed by the small camera 8 and present only on the sub image SG. In other words, each small monitor 7 displays an image in which the image of the real space photographed by each small camera 8 is synthesized with images of various kinds of objects such as the enemy character AC as the sub image SG.

Various kinds of objects present in the image of the real space are dealt in the same manner as various kinds of objects in the virtual 3D game space present in the large monitor 4. In other words, the enemy character AC is dealt as a target on which an action such as an attack is executed, similarly to when the enemy character AC is present in the main image MG. A sighting marker SM representing the position that the muzzle 5j faces is displayed on the center of each sub image SG. FIG. 6 illustrates an example in which the sighting marker SM overlaps one of the enemy characters AC, and the trigger unit 5T of the second gun-type controller 5B is operated in this state.

As described above, the player causes the game to progress based on the range displayed on the main image MG of the virtual 3D game space, and the player is required to cope with an extended real space in which images of various kinds of objects are synthesized with the image of the real space through the small monitor 7. Incidentally, various kinds of other information such as a gauge as well as the above-mentioned information are appropriately displayed on the large monitor 4 and each small monitor 7.

Next, a process executed by the image processing unit 16 (see the control unit 10 of FIG. 3) will be described. The image processing unit 16 renders the main image MG according to a procedure of a so-called 3D computer graphics process in order to display the above-described main image MG on each monitor 4. The rendering is actualized such that the image processing unit 16 constructs the virtual 3D game space, sets a virtual camera in the virtual 3D game space, and generates a 2D image of a space photographed by the virtual camera.

Specifically, the image processing unit 16 controls a point-of-view position and a photographing direction of the virtual camera, and virtually photographs a space of a part of the 3D virtual game space through the virtual camera. In addition, the image processing unit 16 calculates a 2D image in which the photographed virtual 3D game space is projected on the virtual screen. And, the image processing unit 16 renders the obtained 2D image on a frame memory, and outputs an image signal corresponding to the rendered image data to the large monitor 4 with a predetermined period. As a result, the main image MG is displayed on the large monitor 4.

Incidentally, a display element such as a gauge to be superimposed on the main image MG is rendered such that the display element is appropriately superimposed on a frame memory. In addition, positions of various kinds of objects and the position of the virtual camera in the virtual 3D game space are defined by 3D coordinates according to a tri-axial orthogonal coordinate system (world coordinates) of X, Y, and Z axes. A series of processes such as arrangement of various kinds of objects in the virtual 3D game space, the point of view of the virtual camera, control of the virtual camera according to the photographing direction, and photographing by the virtual camera are performed using a known process such as a modeling process and a rendering process in the 3D computer graphics process.

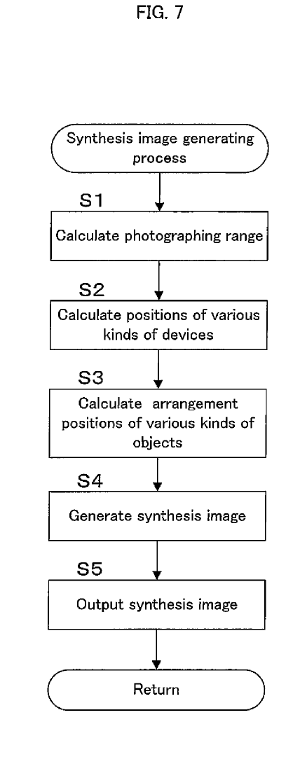

Further, in order to cause the sub image SG to be displayed on the small monitor 7, the image processing unit 16 executes a synthesis image generating process illustrated in FIG. 7 with a predetermined period (or when a certain condition such as a progress state of a game is satisfied). FIG. 7 is a flowchart illustrating an example of a synthesis image generating process routine executed by the image processing unit 16. As illustrated in FIG. 7, in step S1, the image processing unit 16 calculates a photographing range photographed by the small camera 8 based on a signal from the sighting detecting sensor SS. Specifically, first, a direction of the muzzle 5j is calculated based on the signal from the sighting detecting sensor SS. For example, this calculation is actualized by calculating a change angle (in both the horizontal direction and the vertical direction) from the initial position set to the muzzle 5j. For example, the position at which a plane forming the muzzle 5j is parallel to the large monitor 4 may be used as the initial position of the muzzle 5j. Then, the image processing unit 16 calculates a predetermined range in a direction in which the muzzle 5j faces based on the calculated direction of the muzzle 5j as the photographing range, so that the process of step S1 is actualized.

Next, in step S2, the image processing unit 16 calculates positions of various kinds of fixed devices such as the large monitor 4, the gun-type controller 5, and the game machine main body 3 in the photographing range. For example, this calculation is actualized by comparing positions of various devices which are set in advance with respect to the initial position of the gun-type controller 5 with the change angle of the gun-type controller 5 and calculating changed positions of various devices in the photographing range.

Next, in step S3, the image processing unit 16 calculates positions of various kinds of objects to be arranged with respect to various kinds of devices by a comparison with the positions of various kinds of devices calculated in step S2. In step S4, a synthesis image in which the image photographed by the small camera 8 is synthesized with images of various kinds of objects is generated on a frame memory such that various kinds of objects are arranged on the positions calculated in step S3. Next, in step S5, an image signal corresponding to image data of the synthesis image generated in step S4 is output to each small monitor 7 in a predetermined period, and then the current routine ends. As a result, the sub image SG is displayed on the small monitor 7.

As described above, according to the game machine of this embodiment, various kinds of objects such as the enemy character AC can be synthesized with the image of the real space photographed by each small camera 8, and the synthesis result can be displayed on each small monitor 7 as the sub image SG. In addition, various kinds of objects in the sub image SG are dealt in the same manner as various kinds of objects in the main image MG. Thus, the space which can be used for the progress of a game or the like can be extended to the real space as well as the virtual 3D game space. Additionally, each small camera 8 is provided in each gun-type controller 5 operated by the player, and the photographing range is set by the player. As a result, since the player's operation can be reflected in the real space to be extended, realistic sensation of the game can be improved. Accordingly, as a result, amusement of the game can be improved.

In the above embodiment, the control unit 10 functions as a synthesis image output device by executing the routine of FIG. 7. In addition, a combination of the small camera 8 and the control unit 10 functions as an image generating device by executing the routine of FIG. 7.

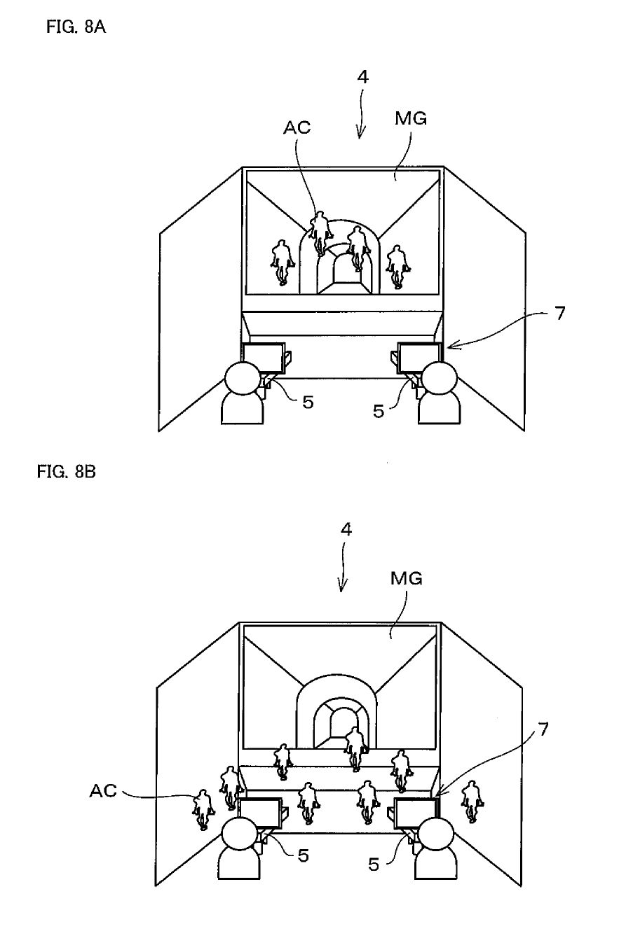

The present invention is not limited to the above embodiment and can be actualized in an appropriate embodiment. In the above embodiment, each small camera 8 is provided in each gun-type controller 5, but the present invention is not limited to this embodiment as long as an area around the main display device 4 can be photographed. For example, the photographing device may be provided in a fixed position different from an input device. FIGS. 8A and 8B are diagrams illustrating an example in which a photographing device is provided in a fixed position. FIG. 8A illustrates an example of an image photographed by the photographing device installed at the fixed position, and FIG. 8B illustrates an example of an image photographed by the photographing device after a predetermined time from the state of FIG. 8A. As illustrated in FIG. 8A, in the photographing range of the photographing device, an area around the main display device 4 including each player, each gun-type controller 5, and the main display device 4 is included. In addition, as illustrated in FIG. 8B, the enemy character AC present in the main image MG of the main display device 4 in FIG. 8A runs out up to the range corresponding to the real space. In this case, each small monitor 7 may be configured so as to calculate a predetermined range in a direction in which the muzzle 5j of each gun-type controller 5 faces and output an image corresponding to the range calculated from the image photographed by the photographing device.

In the above embodiment, the image photographed by each small camera 8 is used as a predetermined image, and various kinds of objects are synthesized with this image, but the present invention is not limited to this embodiment. For example, the photographing device may not be provided, and a 2D image generated based on a space of a part of the virtual 3D game space may be used as the predetermined image. In this case, for example, based on the same image representing the form of the same virtual 3D space, an image including a friendly character can be displayed on the main display device, and an image in which the enemy character is synthesized with the friendly character (that is, an image in which a character that is the friendly character on the main display device changes to the enemy character on the sub display device) can be displayed on the sub display device. As a result, the virtual 3D game space can have multiplicity. Alternatively, when a range of the virtual 3D game space which is in common with the main display device is calculated as a range to be displayed on the sub display device, a 2D image based on the virtual 3D space may be used; when the other ranges are calculated as ranges to be displayed on the sub display device, an image photographed by the photographing device may be used, so that a synthesis image may be generated by combining the virtual 3D game space with the real space.

In the above embodiment, an operation of the gun-type controller is used as the player's action, but the present invention is not limited to this embodiment. For example, the player's line of sight may be used as the player's action. For this reason, in the above embodiment, a gyroscopic sensor or the like is used as an example of the detecting device that detects an operation of the input device, but a target detected by the detecting device is not limited to this operation. Thus, a device that can detect the player's action may be used as the detecting device. A known line-of-sight detecting sensor may be used as an example of the detecting device that detects the player's action to detect the player's line of sight. In addition, as an example of the line-of-sight detecting sensor, there may be used a sensor of a type that receives infrared light irradiated toward an observer (player) from a plurality of places around an observation target (the large monitor 4 or the like) through a light receiving unit installed at an observer side, and detects a direction in which the light receiving unit faces based on a light reception state. Alternatively, a camera may be used as another example of the detecting device. As an example of an embodiment in which a camera is used as the detecting device, the player's action such as a direction of the muzzle of the gun-type controller may be detected by processing an image photographed by the small camera 8 installed in the gun-type controller, an image photographed by a camera installed around the player, or the like.

In addition, the condition such as the predetermined period or the progress state of a game is used as an example of the execution condition of the routine of FIG. 7, but the present invention is not limited to these conditions. For example, an option of a game, a level of a player, a certain operation of a player, or the like may be used as the execution condition of the routine of FIG. 7. In addition, the small monitor 7 is not limited to the embodiment in which the small monitor 7 is installed in the input device, and for example, the small monitor 7 may be installed at a fixed position near the input device. In addition, In the above embodiment, the gun-type controller imitating a gun is used as the input device, but the present invention is not limited to this embodiment, and, for example, various input devices such as an input device imitating a bow may be used as the input device.

1. A game system in which a two-dimensional (2D) image is generated based on a virtual three-dimensional (3D) space used for a progress of a game, and a game screen using the 2D image is displayed on a main display device, and wherein the game system comprises:
a sub display device separate from the main display device;
an image generating device adapted and configured to generate a predetermined image to be output to the sub display device; and
a synthesis image output device adapted and configured to synthesize a predetermined image generated by the image generating device with another image, and output a synthesis result to the sub display device.

2. The game system according to claim 1, further comprising a photographing device adapted and configured to be able to photograph an area around the main display device, wherein
the photographing device is used as the image generating device, and
an image photographed by the photographing device is used as the predetermined image.

3. The game system according to claim 2, further comprising an input device adapted and configured to receive a player's operation, wherein
the photographing device is provided in the input device, and
the input device is configured so as to be able to move such that the photographing device can photograph an area around the main display device.

4. The game system according to claim 1, further comprising a detecting device adapted and configured to detect a player's action, and wherein
the image generating device generates a 2D image of a space of a part of the virtual 3D space based on the player's action detected by the detecting device as the predetermined image.

5. The game system according to claim 4, further comprising an input device adapted and configured to be movable and receive a player's operation, and wherein
the detecting device is provided in the input device and detect an operation of the input device as the player's action, and
the input device has a movable range which is set such that the whole space of the virtual 3D space corresponding to the game screen can be set as the part of the space.

6. The game system according to claim 3, wherein a gun-type controller imitating a gun is used as the input device.

7. A control method of controlling a computer incorporated in a game system in which a two-dimensional (2D) image is generated based on a virtual three-dimensional (3D) space used for a progress of a game, and a game screen using the 2D image is displayed on a main display device, and wherein the game system comprises a sub display device separate from the main display device and the control method of controlling the computer comprises the steps:
an image generating step that generates a predetermined image to be output to the sub display device; and
a synthesis image output step that synthesizes a predetermined image generated by the image generating device with another image, and output a synthesis result to the sub display device.

8. A non-transitory computer readable storage medium storing a computer program for a game system in which a two-dimensional (2D) image is generated based on a virtual three-dimensional (3D) space used for a progress of a game, and a game screen using the 2D image is displayed on a main display device, and wherein the game system comprises a sub display device separate from the main display device and the computer program is configured so as to cause a computer which is incorporated in the game system to serve as:
an image generating device adapted and configured to generate a predetermined image to be output to the sub display device; and
a synthesis image output device adapted and configured to synthesize a predetermined image generated by the image generating device with another image, and output a synthesis result to the sub display device.
